(19) United States
(12) Patent Application Publication
(10) Pub. No.: US 2002/0098061 A1
(43) Pub. Date: Jul. 25, 2002

(54) TAPERED FASTENER FOR DEFORMING PARENT MATERAL APERTURE WHEREBY THE APERTURE CONFORMS TO FASTENER TAPER

(75) Inventor: Frank J. Cosenza, Santa Barbara, CA (US)

Correspondence Address: Irving Keschner, Suite 1150, 21515 Hawthorne Boulevard, Torrance, CA, 90503, US

(73) Assignee: Fastenair, Inc.

(21) Appl. No.: 09/767,592

(22) Filed: Jan. 24, 2001

(51) Int. Cl. F16B 23/00; F16B 15/08

(52) U.S. Cl. 411/454

(57) ABSTRACT

A protruding head fastener incorporates a slight head taper that gradually increases in diameter as it moves in the opposite direction from the female threaded section formed in a parent material. The fastener head engages the mating non-tapered counterbore located in the parent material, the counterbore being slightly larger than the outside diameter of the tapered head portion of the fastener closest to the threads and slightly smaller than the outside diameter of the outward taper of the fastener at the farthest position away from the threads. As the male fastener engages the female threads, the taper of the head of the male fastener abuts against the non-tapered counterbore of the parent material. An interference condition occurs and the mechanical advantage of the threads rotationally pull the tapered head into the counterbore. The counterbore material then begins to yield and deform slightly to conform to a precise matching taper fit with the head of the male fastener. Further torquing will seat the fastener into a locking torque position that resists loosening as a result of the mating of the two surfaces.

### BACKGROUND OF THE INVENTION

1. Field of the Invention

The present invention provides a self-locking fastener that incorporates a taper configuration in the head area of the fastener, in one embodiment, and the shank in a second embodiment.

2. Description of the Prior Art

A number of prior art systems have been developed to solve the problem of bolts or screws loosening after installation. One of the most popular techniques has been the physical deformation of the female thread formed in a parent material or nut in an effort to create sufficient friction with the male thread inserted in the female thread. Although these systems generally have been successful, there still remain issues of degrading torque values and loosening when reusability is incurred. Other designs have included deformed male threads, polymer adhesives attached to male threads, adhesive coatings that glue the threads and other additional parts that have devices added to the assembly of the fastener to improve locking, etc. These designs usually result in additional costs and assembly time due to the increase in assembly operations and parts.

Another prior art device utilizes a taper shank and requires a precision matching taper hole in the parent material. The male thread is pulled into position by a nut for final seating. However, the taper is slight and the deformation of the parent material minimal. This fastener design requires through holes and the taper configuration be precisely tapered reamed through both the outer and inner panels. This specific design is disclosed for example, in Briles Patent Nos. 3,921,364, 4,050,833 and RE030997. The original purpose of these patents was to improve joint fatigue life rather than providing a locking feature.

Therefore what is desired is a fastener assembly that is simple, free of additional parts and expensive operations, and provides repeatable self-locking characteristics.

### SUMMARY OF THE PRESENT INVENTION

The present invention provides a taper configuration in either the protruding head or shank area or both, of a male threaded fastener. Normal protruding head fasteners like filisters or socket head versions, possess cylindrical heads that are parallel to the axis of the screw thread. In the preferred embodiment a protruding head fastener incorporates a slight head taper that gradually increases in diameter as it moves in the opposite direction from its thread. The fastener head engages the mating non-tapered counterbore located in the parent material, the counterbore being slightly larger than the outside diameter of the tapered head portion of the fastener closest to the threads and slightly smaller than the outside diameter of the outward taper of the fastener at the farthest position away from the threads. The mating counterbore is not tapered; the taper of the head of the male fastener thus not being matched. The counterbore is constructed to standard fabrication techniques and standard tooling and is cylindrical in shape. As the male fastener engages the female threads, the taper of the head of the male fastener abuts against the non-tapered counterbore of the parent material. An interference condition occurs, and the mechanical advantage of the threads rotationally pull the tapered head into the counterbore. The counterbore material then begins to yield and deform slightly to conform to a precise matching taper fit with the head of the male fastener. Further torquing will seat the fastener into a locking torque position that increases the locking friction thereby resisting loosening as a result of the precise mating of the two surfaces.

In a second embodiment, when flush head fasteners are required, the same concept is adapted to the unthreaded shank of the male fastener. In this configuration, the unthreaded shank has a taper diameter that is smaller than the untapered hole in the parent material. As the shank taper progresses toward the head of the fastener, the taper is larger than the hole in the parent material, the final assembly of the male fastener mating exactly with the newly formed taper in the parent material.

A distinctive aspect of the present invention is that once the fastener is in the locking mode, further torquing is only applied through the head of the fastener and not the threads. The frictional torque resistance is absorbed by the engagement of the tapered fastener head against the newly complying counterbore taper. This loading begins before there is a ultimate torque tension load on the shank or threads, thus minimizing thread strippage or failures.

### DESCRIPTION OF THE DRAWING

For better understanding of the present invention as well as other objects and further features thereof, reference is made to the following description which is to be read in conjunction with the accompanying drawing therein:

FIGS. 1(a)-1(d) illustrate a conventional prior art fastener assembly;

FIG. 2(a)-2(e) illustrates a first embodiment of the fastener assembly of the present invention;

FIG. 3 shows in more detail the installed male fastener in the first embodiment of the present invention;

FIGS. 4(a) and 4(b) illustrate dimensional details of the tapered fastener head;

FIGS. 5(a)-5(d) illustrate a conventional prior art fastener assembly; and

FIGS. 6(a)-6(d) illustrate a second embodiment of the present invention.

### DESCRIPTION OF THE INVENTION

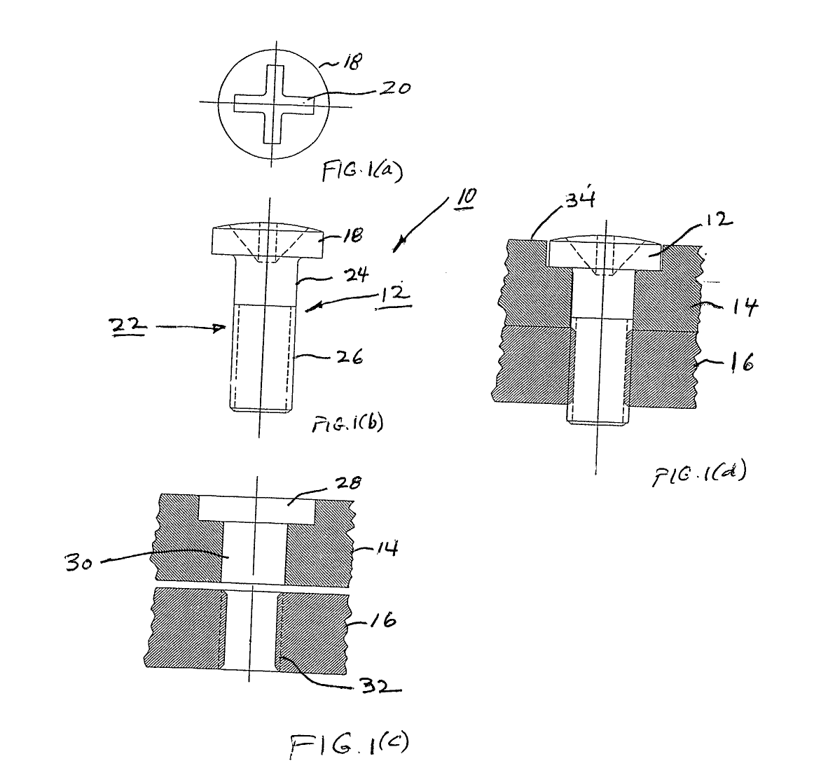

Referring now to FIGS. 1(a)-1(d), an unassembled, conventional fastener system 10 is illustrated. System 10 comprises male thread, or screw, 12 and panels 14 and 16. Male thread 12 comprises head portion 18 having an appropriate driving recess 20 formed therein (a cross recess is illustrated in the figures) and shank portion 22 having an unthreaded portion 24 and threaded portion 26. Panel 14 has a counterbore 28 and non-tapered opening 30 formed therein; panel 16 has a threaded opening 32 formed therein.

FIG. 1(d) illustrates male thread 12 installed, or assembled, in a manner to securely join panels 14 and 16 together. As illustrated, head 18 extends slightly above the upper surface 34 of panel 14.

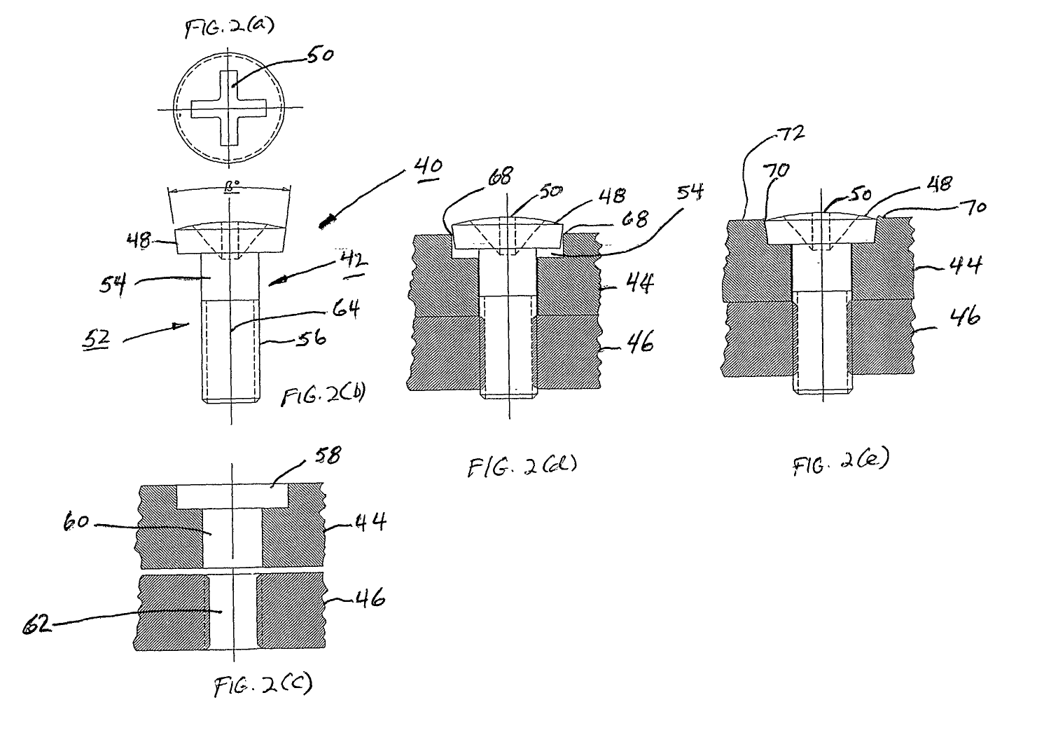

Referring to FIGS. 2(a)-2(c) , an unassembled fastener system 40 in accordance with the first embodiment of the present invention is illustrated. System 40 comprises male thread, or screw head, 42 and panels 44 and 46. Male thread 42 comprises head portion 48 having cross recess 50 formed therein and shank portion 52 having unthreaded portion 54 and threaded portion 56. Panel 44 has a counterbore 58 and a non-tapered hole 60; panel 46 has threaded opening 62. The diameter of the counterbore 58 is coordinated with the dimensions and tolerance of male thread 42. As shown, the sides of head portion 48 are formed at an angle B to the vertical axis 64 of male thread 42 thus forming a taper on head portion 48.

FIG. 2 (d) illustrates male thread 42 partially installed; in the figure, the tapered sides of head 48 at point 68 are just contacting the adjacent surface of bore 58. FIG. 2(e) illustrates system 40 fully installed, or assembled, male thread 42 securing together panels 44 and 46. As the head portion 48 is installed, small amounts 70 of the material which comprises panel 44, typically metal, flows onto the upper surface 72 of panel 44 as illustrated. The circumferential inner surface of bore 58 deforms to the tapered shape of the sides of head portion 48 to form a secure lock. The materials forming male thread 42 and panel 44 are selected such that the former is harder than that of the latter to allow the deformation process to take place. For example, male thread 42 may comprise steel; panel 44 may comprise aluminum.

The male fastener 42 is fabricated in a conventional manner except that an angle is constructed axially from the base head and the angle and head diameter is larger than the counterbore 58 at the top of head portion 48. Counterbore 58 is not tapered, and has a minimum diameter slightly larger than the maximum base of head portion 48, the maximum diameter of counterbore 58 being slightly smaller than the top of the angled head portion 48.

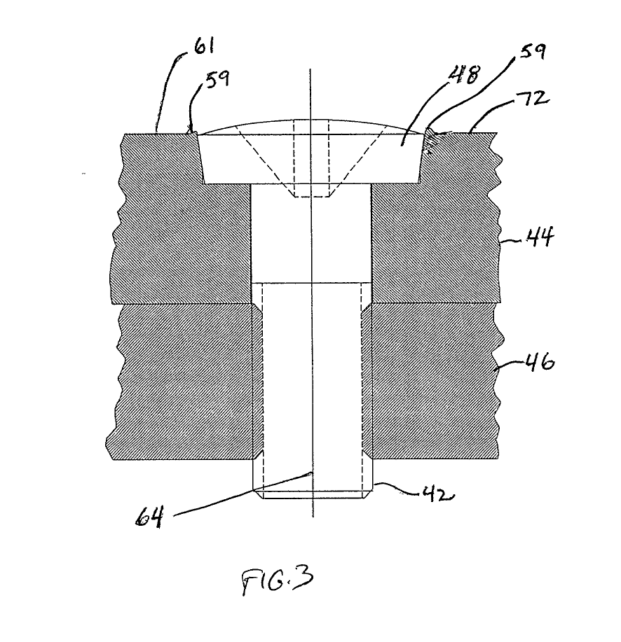

FIG. 3 is a more detailed view showing the assembled system 40 and, in particular, the tapered circumferential surface of counterbore 58. Deplaced material 59 from the tapered head causes a slight annular ring to be formed on surface 61.

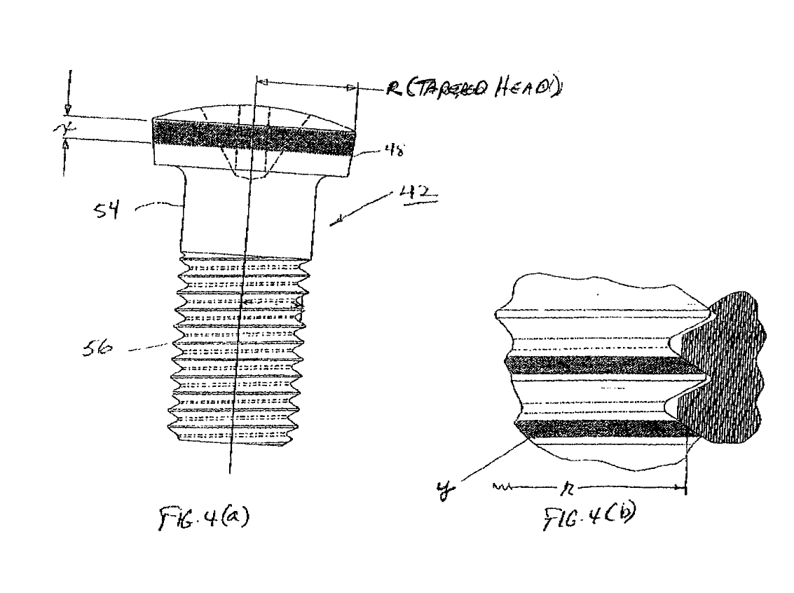

FIGS. 4(a) and 4(b) illustrate typical dimensions of the male thread 42. In particular, dimension x corresponds to the tapered head locking friction band (minimum is 0.5 counterbore depth×circumference of tapered head screw; r equals thread pitch diameter/2 for the threads, r equals normal head diameter/2 for the head); and y is the thread friction band (screw major diameter minus maximum tap drill diameter×2thread circumference).

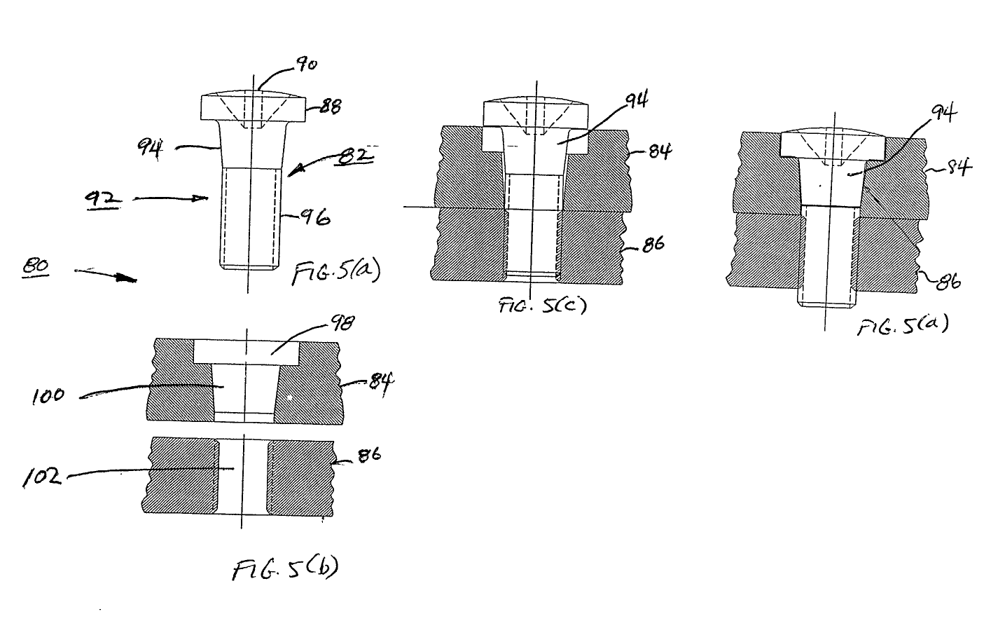

FIGS. 5(a) and 5(b) illustrate an unassembled fastener system 80 in accordance with prior art. System 80 comprises male thread, or screw, 82 and panels 84 and 86. Male thread 82 comprises non-tapered head portion 88 having a driving recess 90 formed therein and shank portion 92 having unthreaded, tapered portion 94 and threaded portion 96. Panel 84 has a counterbore 98 and tapered hole portion 100 formed therein; panel 86 has a threaded opening 102 formed therein.

FIG. 5(c) illustrates a partially assembled system with tapered shank portion 94 entering into tapered portion 100 of panel 84. FIG. 5(d) shows the assembled system 80 with the tapered shank portion 94 in full engagement with the tapered diameter of shank portion 100 to form a locking taper, thus securing panels 84 and 86 together.

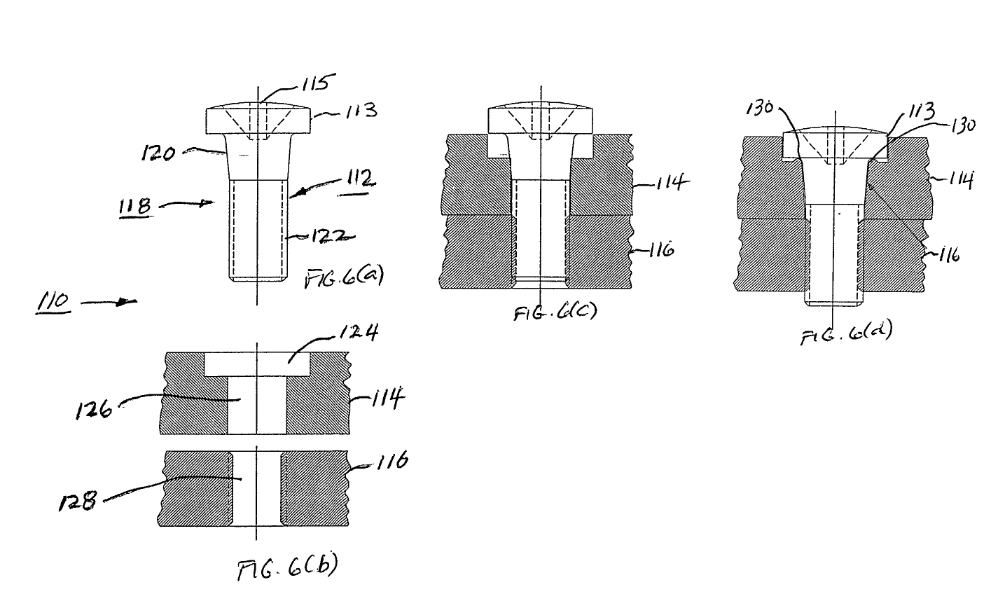

FIGS. 6(a) and 6(b) illustrate an unassembled fastener system 110 in accordance with a second embodiment of the present invention. System 110 comprises male thread, or screw, 112 and panels 114 and 116. Male thread 112 has a head portion 113, a driving recess 115 being formed therein, a shank portion 118 has unthreaded, tapered portion 120 and threaded portion 122. Panel 114 has a counterbore 124 and non-tapered hole portion 126 formed therein; panel 116 has a threaded opening 128 formed therein.

FIG. 6(c) illustrates a partially assembled system with tapered shank portion 120 entering into non-tapered portion 126 of panel 114. As the installation progresses such that the assembly is complete as shown in FIG. 6(d), shank portion 120 causes the hole portion 126 to deform and take the shape of tapered portion 120, forming a secure locking taper. As illustrated, the flow 130 (exaggerated in the Figure) of deformed material prevents head portion 113 from being fully seated in counterbore 126. However, a pre-chamfer formed in the upper portion of hole 126 under the bottom surface of counterbore 124 will allow full seating of head portion 113 within the counterbore.

The present invention thus provides a fastener assembly which has improved resistance to screw unloosening, has lower fabrication costs and wherein an increase in wrench torque causes the resistance to unloosening to also increase.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed:

1. A fastener assembly comprising:
a fastener member having head and shank portions, said fastener member having a longitudinal axis, said head portion having an external surface which forms an angle with said vertical axis thereby forming a taper thereon; and
first and second panel members, said first panel member having first and second surfaces, a counterbore and an opening operatively connected to said counterbore, said second panel member having an opening aligned with the opening in said first panel member, the head portion of said fastener member being seated in said counterbore thereof securing said first and second panel members together.

2. The assembly of claim 1 wherein said head portion has a driving recess formed therein.

3. The assembly of claim 1 wherein the inner surface of said counterbore is deformed to the tapered outside shape of said head portion.

4. A fastener assembly comprising:
a fastener member having head and shank portions, said fastener member having a longitudinal axis, said shank portion having an external surface which forms an angle with said vertical axis thereby forming a taper thereon; and
first and second panel members, said first panel member having first and second surfaces, a counterbore and a tapered opening operatively connected to said counterbore, said second panel member having an opening aligned with the tapered opening in said first panel member, the head portion of said fastener member being seated in said counterbore thereof securing said first and second panel members together.

5. The assembly of claim 4 wherein said head portion has a driving recess formed therein.

6. The assembly of claim 4 wherein the inner surface of said tapered opening is deformed to the tapered outside shape of said shank portion.

7. A fastener assembly comprising:
a fastener member having head and shank portions, said fastener member having a longitudinal axis, said shank portion having an external surface which forms an angle with said vertical axis thereby forming a taper thereon; and
first and second panel members, said first panel member having first and second surfaces, a counterbore and an opening operatively connected to said counterbore, said second panel member having an opening aligned with the opening in said first panel member, the head portion of said fastener member being seated in said counterbore thereof securing said first and second panel members together.

8. The assembly of claim 7 wherein said head portion has a driving recess formed therein.

9. The assembly of claim 7 wherein the inner surface of the opening in said first panel member is deformed to the tapered outside shape of said shank portion.
